(19) United States
(12) Patent Application Publication
(10) Pub. No.: US 2020/0292372 A1
(43) Pub. Date: Sep. 17, 2020

(54) FLUID CONTAINER HAVING A DEVICE FOR FILL LEVEL MONITORING

(71) Applicant: Continental Teves AG & Co. OHG, Frankfurt am Main (DE)

(72) Inventors: Stephan Schlicht, Nauheim (DE); Horst Krämer, Ginsheim-Gustavsburg (DE); Manfred Rüffer, Sulzbach (DE); Werner Krebs, Hambach (DE); Swen Ottmann, Frankfurt am Main (DE)

(73) Assignee: Continental Teves AG & Co. OHG, Frankfurt am Main (DE)

(21) Appl. No.: 16/892,602

(22) Filed: Jun. 4, 2020

Related U.S. Application Data
(63) Continuation of application No. PCT/EP2018/078727, filed on Oct. 19, 2018.

(30) Foreign Application Priority Data
Dec. 13, 2017 (DE) 10 2017 222 672.2

(51) Int. Cl. G01F 23/72

(52) U.S. Cl. CPC G01F 23/72

(57) ABSTRACT

A fluid container having a device which is arranged in an interior space within the fluid container and which serves for monitoring the fill level of a fluid, the device comprising a linearly movable position encoder having a magnet element, the position of which correlates with the fill level of the fluid in the fluid container, and comprising a signal unit, which generates at least one electrical signal in a manner dependent on the position of the magnet element.

### CROSS REFERENCE TO RELATED APPLICATIONS

This application claims priority to PCT International Application No. PCT/EP2018/078727, filed Oct. 19, 2018, which claims priority to German Patent Application No. DE 10 2017 222 672.2, filed Dec. 13, 2017, wherein the contents of such applications are incorporated herein by reference.

### TECHNICAL FIELD

Fluid containers having a device for monitoring a fill level of the fluid.

### TECHNICAL BACKGROUND

DE 10 2010 042 646 A1 has disclosed for example a fluid container designed as a brake fluid container of a motor vehicle brake system. The fluid container has a device for detecting the minimum fill level of the brake fluid introduced. For this purpose, the device has a signal unit having an inexpensive and operationally reliable reed switch, which is activated by an annular magnet and in the process closes an electrical circuit. The reed switch is arranged in the container at the height of the permissible minimum fill level in a vertical, cylindrical guide tube. The annular magnet is accommodated in an annular float and, together therewith, forms a position encoder which is arranged around the guide tube and which is guided thereon. A reed switch responds only digitally to the magnetic field strength above a certain threshold, and thus provides a single, fixed evaluation point. However, the magnetic field of a magnet, which can be commonly used, forms not only a main lobe but also spatially offset side lobes, which could also activate the reed switch. In order to avoid incorrect switching, the free movement of the position encoder, in terms of the possible movement range of the latter, is therefore limited to a considerable extent by suitable stops, wherein the lower stop also defines the fill level to be monitored. The measurement point is thereby defined in a structural manner and cannot be altered, calibrated, or adapted, at a later stage.

In order to compensate for lining wear, brake fluid, owing to the construction, is displaced from the brake fluid container into the wheel brakes, the fill level in the brake fluid container dropping as a result. Also, environmental influences, such as in particular temperature or air humidity, cause natural variations in the fill height. Since reliability of braking nevertheless has to be ensured for a defined period of time or distance, a safety supply of brake fluid is carried in the fluid container beneath the switching position, which increases the dimensions of the fluid container with disadvantages in terms of the required installation space.

Furthermore, the monitoring of functionality is considered to be in need of improvement. In this regard, blocking or jamming of the position encoder cannot be reliably detected, for example. With the known device, it is also the case that it is possible only for extreme leakage, such as for example in the event of a total failure of a brake circuit, to be signalled. Gradual leakage, on the other hand, could remain undetected for a long period of time.

What is needed is an improved fluid container which has reliable fill level monitoring and by way of which the aforementioned disadvantages could be avoided.

### BRIEF DESCRIPTION OF THE DRAWINGS

FIG. 1 shows a known fluid container of the generic type with a reed switch in the signal unit,

FIG. 2 shows a first embodiment of the fluid container with a Hall element in the signal unit and with a guide tube which extends forward as far as the base,

FIG. 3 shows a second embodiment of the fluid container with a Hall element in the signal unit and with a projection which extends from the base forward to the guide tube and which serves for continuing the encoder element.

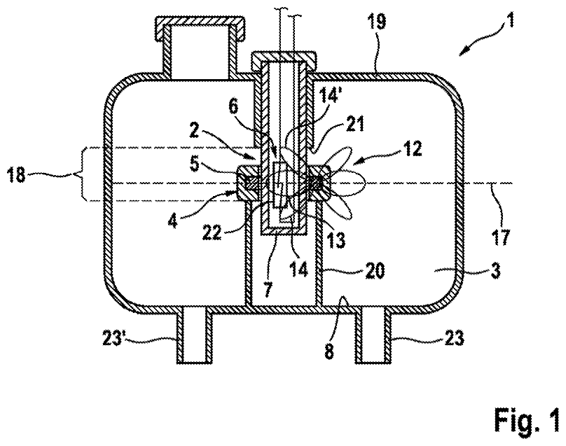

### DETAILED DESCRIPTION OF THE EMBODIMENTS

The detailed description includes references to the accompanying drawings, which form a part of the detailed description. The drawings show, by way of illustration, specific embodiments in which the apparatus or system may be practiced. These embodiments, which are also referred to herein as “examples” or “options” or “alternatives” are described in enough detail to enable those skilled in the art to practice the present embodiments. The embodiments may be combined, other embodiments may be utilized, or structural or logical changes may be made without departing from the scope of the invention. The following detailed description is not to be taken in a limiting sense and the scope of the invention is defined by the appended claims and their legal equivalents.

The fluid container 1 has a housing 19 which is able to be filled with a fluid. The hydraulic interfaces 23,23′ connect the interior space 3 of the container 19 to the brake system (not shown here) and make it possible for the fluid to circulate. For reliable functioning of the brake system, a minimum quantity of the fluid is required, which minimum quantity of the fluid defines a minimum fill level in a manner dependent on the condition of the container 19 and possibly on a defined safety factor in the housing 19.

A guide tube 7 is arranged in the interior space 3 of the housing 19 in a vertical alignment. A signal unit 6 having a reed switch 22 is accommodated in the guide tube 7. The reed switch 22, by way of its position, defines a switching point 17, which is provided at the height of the minimum fill level to be monitored by structural design.

A position encoder 4 is guided on the guide tube 7. The position encoder 4 is designed as an annular float which floats on the fluid surface, thereby marking the present fill level by way of its position. An annular magnet element 5 is arranged in the position encoder 4. The magnet element 5 is in the form of a permanent magnet and generates a constant magnetic field 12, which has an irregular shape and is represented here in a highly simplified manner by a relatively large main lobe 13 and relatively small side lobes 14, 14′ which are spatially offset from the main lobe 13. The magnetic field 12 puts the reed switch 22 into a switched state, in which an electrical circuit is closed and a warning signal is consequently generated.

In order to ensure that the warning signal is present even after the fluid has dropped below the minimum fill level, the movement of the position encoder 4 in the downward direction is limited by a lower stop 20, which is integrally formed on the base 8 of the housing 19. In order to prevent incorrect switching by way of the side lobe 14, the movement of the position encoder 4 in the upward direction is limited by an upper stop 21. The spacing along the guide tube 7 between the upper 21 and lower 20 stops thus defines a movement range of the encoder element 4.

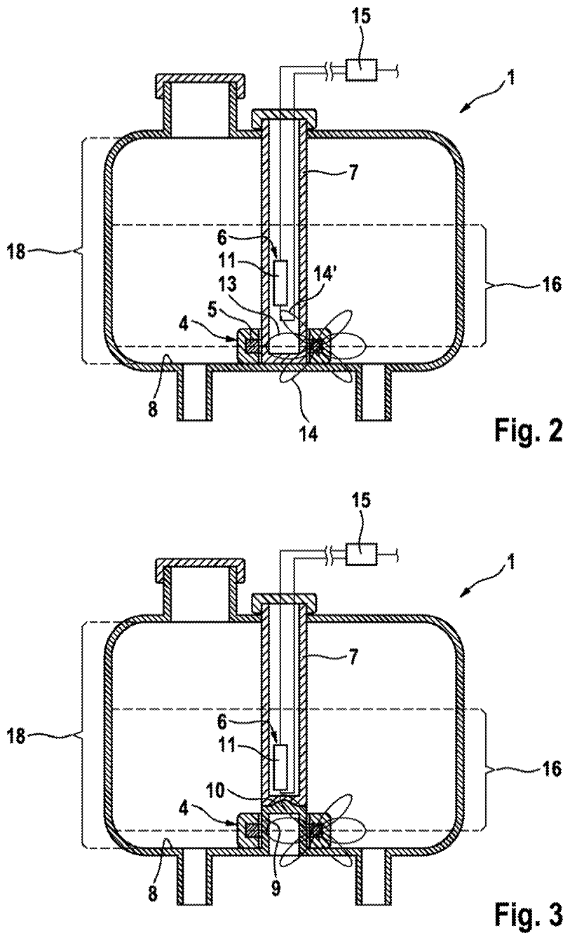

A first embodiment according to the invention of the fluid container 1 is shown in simplified form in FIG. 2. By contrast to the above-described known embodiment, the signal unit 6 has a Hall element 11 which is arranged in the guide tube 7. The guide tube 7 is designed so as to be extended such that it reaches as far as the base 8 of the housing 19 of the fluid container 1. Moreover, the movement-limiting stops 20,21 are not present, as a result of which the movement range 18 of the position encoder 4 extends over the entire possible fill height of the fluid container 1.

As is known, a Hall element through which current flows generates an output voltage which is proportional to the product of magnetic flux density and current. Said Hall element hereby has, by contrast to the reed switch, an analog behavior. The fact that the flux densities of the main and side lobes 13,14,14′ of the magnetic field 12 generated by the magnet element 5 are constant and known means that, from the magnitude of the output voltage and the temporal variation thereof, it is possible to calculate the distance of the magnet element 5 from the Hall element 11 and the direction of movement and speed of movement of said magnet element within an extended detection range 16. For this purpose, the measurement device according to the invention is assigned an electronic evaluation unit 15 which controls and supplies current to the signal unit 6 and which evaluates the output voltage. The detection range 16 may be more than 10 mm in size according to requirement and component assembly. In one or more embodiments, the detection range 16 is more than 20 mm in size, and ideally it extends over the entire fill height of the fluid container 1.

The Hall element 11 may, according to the set requirements and the construction of the fluid container 1, be positioned such that the detection range 16 covers the desired range of the fill level height, optionally the entire possible fill height. If necessary, it is possible within the scope of the invention for multiple Hall elements 11 to be arranged spaced apart from one another at different height positions in order to further increase the detection range 16, if for example the range of a single Hall element 11 is not sufficient. Also within the scope of the invention, it is conceivable for multiple Hall elements to be redundantly placed at the same height position so as to increase the failure safety.

FIG. 3 shows a second embodiment according to the invention of the fluid container 1. By contrast to the embodiment according to FIG. 2, the guide tube 7 is of shortened design. At the same time, a projection 9 rises from the base 8 in the direction of the guide tube 7 and is provided for continuing the position encoder 4 as far as the base 8.

For secure mounting of the guide tube 7 and unhindered guidance of the position encoder 4, provision is made between the guide tube 7 and the projection 9 of a form-fitting centering device 10, which, when the guide tube 7 is mounted, forcibly ensures coaxial alignment of the two with respect to one another.

In the embodiment shown, the centering device 10 is formed as a conical elevation at the end of the projection 9 that engages into a complementary depression at the end of the guide tube 7. It goes without saying that other functionally equivalent variants of the centering device 10 are also permissible within the scope of the invention.

The invention provides that, for detecting the position of the magnet element, the signal unit has at least one Hall element. Owing to the proportionality of the output voltage to the magnetic field strength, the position of the position encoder can moreover be determined continuously instead of at a fixed switching point within an extended detection range. It is also possible for leakage to be detected on the basis of positional variation of the position encoder within the detection range. For example, the fill height can be determined when the vehicle is at a standstill or is started, and compared with further information, such as for example a lining wear indicator, whereupon, in the event of unexpected deviations, a response at an early point in time is possible.

It also becomes possible to use software to calibrate the device for fill level monitoring, for example for compensation of manufacturing tolerances, reproduction of variants or compensation of temperature-induced fill level variations.

According to an advantageous refinement of the invention, the signal unit may be arranged substantially within a guide tube, and the position encoder may be guided on the same guide tube and be movable substantially as far as a base of the fluid container.

This makes it possible for reliable measurement of the actual residual volume in the fluid container to be carried out. A reserve supply can be significantly reduced or completely dispensed with. Consequently, less fluid has to be carried and the container dimensions can be reduced. Owing to the smaller fluid supply, the mechanical load on the housing is reduced, and consequently the wall thickness can, in a material- and cost-saving manner, also be reduced. Weight is reduced.

According to a first embodiment according to the invention, the guide tube may be designed so as to extend forward substantially as far as the base of the fluid container, in order to realize the extended movement range of the position encoder and detection range of the measurement device. In this way, the advantages of the invention are achieved by way of a particularly simple design of the housing.

According to a second embodiment according to the invention, a projection extending forward in the direction of the guide tube may be provided on the base of the fluid container, said projection likewise being suitable for guidance of the position encoder and, together with the guide tube, making possible unhindered mobility of the position encoder as far as the base of the fluid container. This allows the length of the guide tube to be kept optimally short with advantages in terms of stiffness and with reduced tendency to vibration without functional disadvantages and without reduction of the movement range. It is also possible for particularly large fill heights to be spanned more easily.

According to an advantageous refinement, provision may be made between the guide tube and the projection of a form-fitting centering device in order to effectively automatically bring about during assembly coaxial alignment of the guide tube with the projection for exact guidance of the position encoder.

The invention furthermore provides that the magnetic field of the magnet element has at least one main lobe and at least one side lobe, which induce different output voltages in the Hall element, and provision is made of an electronic evaluation unit, which, on the basis of the output voltages induced in the Hall element by the main and/or side lobes, determines a unique position of the position encoder within a detection range, which makes possible continuous monitoring of the position of the position encoder with determination of any main events and intermediate states. By comparing the results thus obtained with other events, such as for example spatial vehicle position or brake lining wear, an extremely reliable plausibility check of the measurement device and functional check of individual components, such as the position encoder or signal unit, can be realized autonomously during vehicle operation.

It is intended for the measurement device, in particular the Hall elements with respect to their technical properties, number and, if appropriate, distribution, to be designed such that the detection range is provided to be greater than 10 mm in size, optionally greater than 20 mm in size, and optionally extends over the entire realizable fill height of the fluid container. This allows effective use of the inner volume of the fluid container, it being possible not only for leakage but also for overfilling to be registered in a timely manner and for suitable countermeasures to be initiated.

It is particularly effectively and advantageously possible for the fluid container according to the invention to be used as a brake fluid container of a hydraulic motor vehicle brake system in order to make effective use of advantages of the increased functionality and of the reduced dimensions. Other usage scenarios, such as for example a washer fluid container for window- or camera-cleaning systems of a motor vehicle, are however likewise possible.

The invention furthermore provides advantageous methods with increased functional scope for operating the fluid container according to the invention.

According to a first method according to the invention, the position of the position encoder can be determined at regular time intervals, in particular continuously, and compared with the fill level values which are expected on the basis of empirical values or model calculations. In the event of a progressive deviation toward a decrease in fill level being established, leakage of the fluid is assumed and an associated warning measure and/or countermeasure is initiated. With this method, it is possible not only for early detection of gradual leakage but also for a plausibility check of the measurement device to be carried out if the measured fill level values are compared for example with measured lining wear values.

According to a second method according to the invention, during driving operation, the position of the position encoder can be determined at regular time intervals, in particular continuously, and checked for correlation with spatial acceleration values of the vehicle, which are able to be established for example with the aid of a yaw rate sensor. If the measured position deviates from an expected position multiple times, an impediment with regard to proper free movement of the position encoder—for example misalignment, jamming, adherence of foreign particles and the like—is assumed and an associated warning measure and/or countermeasure is initiated.

### LIST OF REFERENCE SIGNS

1 Fluid container
2 Measurement device
3 Interior space
4 Position encoder
5 Magnet element
6 Signal unit
7 Guide tube
8 Base
9 Projection
10 Centering device
11 Hall element
12 Magnetic field
13 Main lobe
14 Side lobe
15 Evaluation unit
16 Detection range
17 Switching point
18 Movement range
19 Housing
20 Lower stop
21 Upper stop
22 Reed switch
23 Interface

1. A fluid container having a device which is arranged in an interior space within the fluid container and which serves for monitoring the fill level of a fluid, the device comprising:
a linearly movable position encoder having a magnet element, the position of which correlates with the fill level of the fluid in the fluid container, and comprising a signal unit, which generates at least one electrical signal in a manner dependent on the position of the magnet element, wherein, for detecting the position of the magnet element, the signal unit has at least one Hall element.

2. The fluid container as claimed in claim 1, wherein the position encoder is guided on a guide tube, the signal unit is arranged substantially within the guide tube, and the position encoder is movable substantially as far as a base of the fluid container.

3. The fluid container as claimed in claim 2, wherein the guide tube extends forward substantially as far as the base of the fluid container.

4. The fluid container as claimed in claim 2, wherein a projection extends from the base of the fluid container forward in the direction of the guide tube and is provided for guidance of the position encoder.

5. The fluid container as claimed in claim 4, wherein provision is made between the guide tube and the projection of a form-fitting centering device for forcibly coaxial alignment of the guide tube with the projection.

6. The fluid container as claimed in claim 1, wherein a magnetic field of the magnet element has at least one main lobe and at least one side lobe, which induce different output voltages in the Hall element, and provision is made of an electronic evaluation unit, which, on the basis of the output voltages induced in the Hall element by the main and/or side lobes, determines a unique position of the position encoder within a detection range.

7. The fluid container as claimed in claim 6, wherein the detection range is provided to be greater than 10 mm in size, preferably greater than 20 mm in size.

8. The fluid container as claimed in claim 6, wherein the detection range is provided to be greater than 20 mm in size.

9. The fluid container as claimed in claim 1, wherein the fluid container is a brake fluid container of a hydraulic motor vehicle brake system.

10. A method for operating a device of a fluid container, the fluid container including a linearly movable position encoder having a magnet element, the position of which correlates with the fill level of the fluid in the fluid container, and comprising a signal unit, which generates at least one electrical signal in a manner dependent on the position of the magnet element, wherein, for detecting the position of the magnet element, the signal unit has at least one Hall element, the method comprising:
determining the position of the position encoder at regular time intervals, and is compared with expected fill level values, which are determined on the basis of a properly functioning motor vehicle brake system with environmental conditions taken into consideration; and
in the event of a progressive deviation toward a decrease in fill level being established, leakage of the fluid is assumed and an associated warning measure and/or countermeasure is initiated.

11. The method as recited in claim 10, wherein determining the position of the position encoder at regular time intervals comprises continuously determining the position of the position encoder at regular time intervals.

12. A method for operating a device of a fluid container, the fluid container including a linearly movable position encoder having a magnet element, the position of which correlates with the fill level of the fluid in the fluid container, and comprising a signal unit, which generates at least one electrical signal in a manner dependent on the position of the magnet element, wherein, for detecting the position of the magnet element, the signal unit has at least one Hall element, the method comprising:
determining the position of the position encoder at regular time intervals during driving operation;
checking for correlation with spatial acceleration values of the vehicle; and
in the event of deviation from an expected position multiple times, an impediment with regard to proper free movement of the position encoder is assumed and an associated warning measure and/or countermeasure is initiated.

13. The method as recited in claim 12, wherein determining the position of the position encoder at regular time intervals during driving operation comprises continuously determining the position of the position encoder at regular time intervals.
